(19) United States
(12) Patent Application Publication
(10) Pub. No.: US 2025/0318551 A1
(43) Pub. Date: Oct. 16, 2025

(54) ENHANCING THE VIRUCIDAL ACTIVITY OF BENZOIC ACID IN FEED

(71) Applicant: DSM IP ASSETS B.V., Heerlen (NL)

(72) Inventors: Maria WALSH, Kaiseraugst (CH); Dengyuan NIU, Kaiseraugst (CH); Haijie SONG, Kaiseraugst (CH); Heng-Xiao ZHAI, Kaiseraugst (CH); Jianan XIE, Kaiseraugst (CH); Shou-Zhen LIU, Kaiseraugst (CH)

(21) Appl. No.: 18/254,254

(22) PCT Filed: Nov. 24, 2021
(86) PCT No.: PCT/EP2021/082889

§ 371 Date: May 24, 2023

(30) Foreign Application Priority Data
Nov. 26, 2020 (WO) PCT/CN2020/131946

(51) Int. Cl. A23K 20/111; A23K 20/158; A23K 50/30

(52) U.S. Cl. CPC A23K 20/111; A23K 20/158; A23K 50/30

(57) ABSTRACT

The present invention allows to reduce the holding time needed to assure viral degradation in feed. In feed, virucidal activity of benzoic acid can be enhanced by essential oils. One embodiment of the invention relates to a method of at least partially inactivating African swine fever virus in pig feed, characterized in that benzoic acid is added together with at least one essential oil to pig feed. The preferred essential oils are thymol and eugenol.

### CROSS-REFERENCE TO RELATED APPLICATIONS

This application is the U.S. national phase of International Application No. PCT/EP2021/082889 filed Nov. 24, 2021, which designated the U.S. and claims priority to International Application No. PCT/CN2020/131946 filed Nov. 26, 2020, the entire contents of each of which are hereby incorporated by reference.

### TECHNICAL FIELD

The present invention deals with the threat of viral pathogens in feed. An example is African swine fever virus (ASFV) contamination in pig feed.

### BACKGROUND OF THE INVENTION

Feed and feed ingredients have been proposed to be contributing factors to the introduction of porcine epidemic diarrhea virus (PEDV) in commercial swine herds. This route of infection has been proven possible in experimental settings (Dee et al. “An evaluation of contaminated complete feed as a vehicle for porcine epidemic diarrhea virus infection of naïve pigs following consumption via natural feeding behavior: proof of concept” BMC Veterinary Research, 2014; 10:176).

The Swine Health Information Center (SHIC), the National Pork Board, the National Pork Producers Council and the American Association of Swine Veterinarians suggest adding more holding time to assure viral degradation in feed. For conventional soybean meal, they recommend 143 days holding time at 4° C. for 99.99% degradation (Swine Health Information Center, “Research on viral transmission in feedstuffs yields, new information”, release on May 7, 2019).

Patricia de León et al. describe laboratory methods to study African swine fever virus (Virus Research, Volume 173, Issue 1, April 2013, pp. 168-179, 2012).

The examples of WO 2019/169256 disclose data about inhibiting African swine fever virus in animal feed by introducing medium chain fatty acids to feed. Preferred medium chain fatty acids are caproic acid, caprylic acid, capric acid and lauric acid.

The virucidal activity of organic acids has been known for a long time. According to Table 1 of Poli et al., the virucidal activity of benzoic acid is relatively poor (Poli et al., “Virucidal activity of organic acids”, Food Chemistry, Volume 4, Issue 4, October 1979, Pages 251-258). Poli et al. suggest that the virucidal activity of propionic acid is higher than the virucidal activity of benzoic acid.

WO 2020/149092 discloses a method of controlling African swine fever virus comprising the step of combining an effective amount of aqueous formaldehyde and propionic acid with animal feed.

Whereas the virucidal activity of propionic acid seems to be high, Poli et al. suggest that the virucidal activity of fumaric acid is even higher. In example 1 of WO 2020/100077, a blend of fumaric acid, benzoic acid and 2-hydroxy-4-(methylthio) butanoate (HMTBA) calcium is used to reduce the risk of infection following consumption of feed contaminated with PRRSV, PEDV and SVA.

None of the solutions of the prior art is satisfactory. For many consumers, feeding formaldehyde to pigs is no longer acceptable. On the other hand, HMTBA and its salts are relatively expensive. Most importantly, none of the solutions of the prior art reduces the required holding time sufficiently. In most cases, a holding time of several weeks is still needed to assure viral degradation in feed. Potentially, holding time could be reduced by increasing the amount of added propionic acid, fumaric acid, HMTBA or formaldehyde. However, adding a high amount of feed additive is not an acceptable as this is would raise cost prohibitively. In addition, thresholds given by regulatory authorities that must be respected.

There is a need to deal with the threat of viral pathogens in feed more effectively and/or at lower cost. Adding formaldehyde to feed is to be avoided, if possible. More specifically, there is a need to further reduce holding time of pig feed that might possibly be contaminated with African swine fever virus (ASFV).

### SUMMARY OF THE INVENTION

The present invention is based on the use of benzoic acid. Considering that several feed additives (e.g. fumaric acid) appear to have a higher virucidal activity than benzoic acid, the choice of benzoic acid is surprising. The problems underlying the present invention are solved by enhancing the relatively low virucidal activity of benzoic acid with one or multiple essential oils. Surprisingly, enhancement of benzoic acid's virucidal activity by an essential oil is more successful in feed than in liquids. African swine fever virus in pig feed, for example, can be inactivated very fast and/or at low cost by adding benzoic acid and at least one essential oil to contaminated pig feed.

Due to the very fast inactivation, holding time of feed can be reduced. A reduction of the holding time lowers cost and/or lowers complexity of the feed supply chain.

One embodiment of the present invention relates to a method of reducing the risk of infection following consumption of feed contaminated with at least one virus, characterized in that benzoic acid and at least one essential oil is added to feed. A preferred embodiment of the present invention relates to a method of at least partially inactivating African swine virus in pig feed, characterized in that benzoic acid and at least one essential oil is added to pig feed.

The present invention also relates to pig feed comprising inactivated African swine fever virus, benzoic acid and at least one essential oil. Inactivated African swine virus can be detected by a PCR method, whereas no hemadsorption occurs in a hemadsorption assay.

A further embodiment of the present invention relates to use of benzoic acid and at least one essential oil, or preferably a composition or mixture comprising benzoic acid and at least one essential oil for at least partially inactivating African swine fever virus preferably in feed, or use of at least one essential oil for enhancing the virucidal activity of benzoic acid in feed. Preferred essential oils are thymol and eugenol. Most preferably, virucidal activity of benzoic acid is enhanced by a mixture of thymol and eugenol. Benzoic acid and the at least one essential oil may be added separately to feed. Alternatively, a mixture of benzoic acid and the at least one essential oil is added to feed. Mixing feed with benzoic acid is particularly easy if benzoic acid flakes are used. Other forms of benzoic acid (such as benzoic acid prills) are less preferred. Mixing feed with one or more essential oil is particularly easy if a powder comprising at least one essential oil is used. Other forms of essential oils (such as liquids) are less preferred. Powders comprising a mixture of eugenol and thymol are particularly preferred. Such powders can be easily mixed with benzoic acid flakes and/or feed.

Thus, the present invention also relates to the use of a powder that comprises a mixture of eugenol and thymol for enhancing the virucidal activity of benzoic acid flakes, preferably in feed and preferably for enhancing the capability benzoic acid flakes to inactivate African swine fever virus in pig feed. An also preferred embodiment of the present invention relates to pig feed comprising inactivated African swine fever virus, benzoic acid flakes and a powder, wherein said powder comprises a mixture of eugenol and thymol.

### BRIEF DESCRIPTION OF THE DRAWING FIGURES

FIG. 1 shows a graphical illustration of the in vitro assay that was done in example 1.

FIG. 2 is a graphical illustration of the assay of example 2. A comparison of FIG. 1 with FIG. 2 reveals that the assays of the two examples are similar. However, the assay of example 1 was done inphosphate-buffered saline (PBS) solution, whereas in the assay of example 2, a feed matrix was used. Surprisingly, the enhancing effect of essential oils on the virucidal activity of benzoic acid is dramatically higher in a feed matrix than in a solution.

### DETAILED DESCRIPTION OF THE INVENTION

The preferred method of the invention is a method to reduce the risk of infection following consumption of feed contaminated with African swine fever virus (AFSV). Pigs are hosts of AFSV and thus, the preferred feed of the invention is pig feed. Thereby, the term “pig feed” is to be understood in a broad manner. The pig feed of the invention is preferably suitable for hogs, swine, piglets, sows and/or boars.

The present invention relates to virucides. Thereby, the terms “virucide” and “viricide” are used synonymously. In the context of the present invention, a virucide is compound or a mixture of compounds that inactivates or destroys at least one virus at least partially. The terms “deactivate” and “inactivate” are also used synonymously.

Typically, inactivation means that remains of the virus maybe still be detected by qPCR, an RT-PCR method or another suitable PCR method. For a healthy animal, such inactivated remains of the virus are most often harmless. It is therefore more relevant to evaluate samples for their ability to produce infective virus. The exploitation of a characteristic feature of the swine monocytes infected with ASFV, which developed a rosette of erythrocytes around the infected cell, has been the basis of a classical assay by “hemadsorption,” widely used both for diagnostic purposes and for virus titrations (see Enjuanes, L. et al., 1976a. Titration of African swine fever (ASF) virus. Journal of General Virology 32 (3), 471-477 as cited in León et al., section 4.1).

The preferred virucide of the invention is benzoic acid. According to the present invention, the virucidal activity of benzoic acid is enhanced by at least one essential oil or preferably by a mixture of essential oils. This does not exclude that the essential oil or the mixture of essential oil is itself a virucide. In the context of the present invention, “enhancement” is to be understood in a broad manner. Preferably however, enhancement is to be understood as increasing the speed at which a virus is inactivated or destroyed. An increase in speed will allow to reduce the holding time of possibly contaminated feed. To determine the speed, PCR methods are not suitable as they are typically not capable to distinguish between harmful virus and harmless, inactivated remains of a virus. Therefore, a biological method such as hemadsorption is needed to determine how many days are needed to inactivate or destroy the virus in the contaminated feed.

The present invention relates to a method, to a use, to feed and to a process. The following preferences apply to all four of them, i.e. to the method, to the use, to the feed and also of the process of the invention: Benzoic acid flakes are the preferred benzoic acid of the invention. Other kinds of benzoic acid such as benzoic acid prills are less preferred but not excluded. Benzoic acid flakes are commercially available at DSM® Nutritional Products (Switzerland).

Essential oils as used in the context of the present invention include: Agar oil, Ajwain oil, Angelica root oil, Anise oil, Asafoetida, Balsam of Peru, Basil oil, Bay oil, Bergamot oil, Black Pepper, Buchu oil, Birch, Camphor, Cannabis flower essential oil, Caraway oil, Cardamom seed oil, Carrot seed oil, Cedarwood oil, Chamomile oil, Calamus Root, Cinnamon oil, Cistus species, Citron, Citronella oil, Clary Sage, Clove oil, Coffee, Coriander, Costmary oil (bible leaf oil), Costus Root, Cranberry seed oil, Cubeb, Cumin oil/Black seed oil, Cypress, Cypriol, Curry leaf, Davana oil, Dill oil, Elecampane, Eucalyptus oil, Fennel seed oil, Fenugreek oil, Fir, Frankincense oil, Galangal, Galbanum, Geranium oil, Ginger oil, Goldenrod, Grapefruit oil, Henna oil, Helichrysum, Hickory nut oil, Horseradish oil, Hyssop, Idaho Tansy, Jasmine oil, Juniper berry oil, Laurus nobilis, Lavender oil, Ledum, Lemon oil, Lemongrass, Lime, Litsea cubeba oil, Linaloe, Mandarin, Marjoram, Melaleuca See Tea tree oil, Melissa oil (Lemon balm), Mentha arvensis oil/Mint oil, Moringa oil, Mountain Savory, Mugwort oil, Mustard oil (essential oil), Myrrh oil, Myrtle, Neem oil or Neem Tree Oil, Neroli, Nutmeg, Orange oil, Oregano oil, Orris oil, Palo Santo, Parsley oil, Patchouli oil, Perilla essential oil, Pennyroyal oil, Peppermint oil, Petitgrain, Pine oil, Ravensara, Red Cedar, Roman Chamomile, Rose oil, Rosehip oil, Rosemary oil, Rosewood oil, Sage oil, Sandalwood oil, Sassafras oil, Savory oil, Schisandra oil, Spearmint oil, Spikenard, Spruce, Star anise oil, Tangerine, Tarragon oil, Tea tree oil, Thyme oil, Tsuga, Turmeric, Valerian, Vetiver oil (khus oil), Western red cedar, Wintergreen, Yarrow oil, Ylang-ylang, and Zedoary. In the context of the present invention, the expression “essential oils” is to be understood in a broad manner and also includes components having an aromatic odor from essential oils such as thymol and eugenol. Thymol and eugenol are the preferred essential oils of the invention. Thereby, it does not matter whether thymol and eugenol have been synthetically produced, have been extracted from a plant or have been obtained in any other manner. More preferably, the at least one essential oil of the invention is a mixture of thymol and eugenol. Even more preferably, one or multiple powders comprising at least one essential oil are used. Most preferably, a powder comprising a mixture of thymol and eugenol is used. Such powders are commercially available at DSM® Nutritional Products (Switzerland) and can be easily mixed with benzoic acid flakes and/or feed. The most preferred powder of the invention comprises a mixture of thymol and eugenol and further comprises at least one excipient, wherein said at least one excipient is preferably 2-methoxyphenol, piperine and/or curcumin, and is more preferably piperine.

The virucidal activity of a compound may depend on the chosen virus. The present invention relates preferably to African swine fever virus (AFSV).

### Method of the Invention

The present invention relates to a method of inactivating virus in feed. Thereby, the inactivation may be partially or fully. In some cases, it might be known that feed is indeed contaminated with a particular virus. In other cases, it might only be suspected that feed could possibly be contaminated.

When applying the method of the present invention, it does not matter whether the feed is indeed contaminated as the purpose of the invention's method is to reduce the risk of infection following consumption of feed. It is therefore not necessary to make a lab analysis of feed before applying the herein disclosed method. Virus that might possibly be present in the feed will be inactivated by the enhanced virucide of the invention—and if no virus is present in the feed, the risk of virus infection due to the consumption of the feed is anyway low or inexistent.

A preferred embodiment of the invention relates to a method of at least partially inactivating African swine fever virus in feed, preferably in pig feed. According to the present invention, African swine fever virus being present in pig feed is at least partially inactivated by adding benzoic acid and at least one essential oil to the pig feed. Many essential oils are volatile liquids. Mixing volatile liquids with feed is challenging. It is therefore preferred to add, together with benzoic acid, one or multiple powders that comprises at least one essential oil. Thus, a preferred embodiment of the invention relates to a method of at least partially inactivating African swine virus in pig feed, characterized in that benzoic acid and at least powder are added to the pig feed, and wherein said powder comprises at least one essential oil and further comprises optionally at least one excipient, and wherein said at least one optional excipient is preferably 2-methoxyphenol, piperine and/or curcumin, and is most preferably piperine.

In the context of the present invention, any essential oil may be used. However, the preferred essential oils are eugenol and thymol, wherein a mixture of eugenol and thymol is even more preferred. In such mixture, the weight ratio eugenol:thymol is preferably from 10:1 to 1:10, more preferably from 5:1 to 1:5 and most preferably from 3:1 to 1:3. A particularly preferred embodiment of the present invention relates to a method of at least partially inactivating African swine fever virus in pig feed, characterized in that benzoic acid flakes and at least powder is added to the pig feed, and wherein said powder comprises a mixture of eugenol and thymol and optionally at least one excipient, and wherein said at least one optional excipient is preferably 2-methoxyphenol, piperine and/or curcumin. Regarding eugenol, the weight ratio between benzoic acid flakes and eugenol is preferably at least 500:1, is more preferably at least 833:1 and is preferably at most 2500:1. Regarding thymol, the weight ratio between benzoic acid flakes and thymol is preferably at least 250:1, is more preferably at least 333:1 and is preferably at most 500:1.

Benzoic acid and the at least one essential oil may be added separately to feed such as pig feed. Alternatively, a mixture of benzoic acid and the at least one essential oil may be added to pig feed. Benzoic acid flakes are easy to mix with powders. Thus, a particularly preferred embodiment of the invention relates to a method of at least partially inactivating African swine virus in pig feed, characterized in that a mixture comprising benzoic acid flakes and at least powder is added to pig feed, and wherein said powder comprises at least one essential oil and comprises preferably a mixture of thymol, eugenol and optionally at least one excipient, and wherein said at least one optional excipient is preferably 2-methoxyphenol, piperine and/or curcumin.

Benzoic acid such as benzoic acid flakes are preferably added in an amount of 0.25 to 0.5 weight-%, more preferably in an amount of 0.25 to 0.475 weight-%, even more preferably in an amount of 0.25 to 0.4 weight-% and most preferably in an amount of 0.25 to 0.39 weight-%, based on the total weight of the pig feed. In an alternative embodiment, benzoic acid flakes are added in an amount of at least 0.5 weight-%, based on the total weight of the pig feed.

Although not preferred, further additives could be added to the pig feed. However, the addition of formaldehyde, medium chain fatty acids, fumaric acid, propionic acid, 2-hydroxy-4-methylthio-butanoic acid and/or salts of 2-hydroxy-4-methylthio-butanoic acid (e.g. 2-hydroxy-4-(methylthio) butanoate calcium) to the pig feed of the invention is neither necessary nor preferred. Further additives increase cost whereas feeding formaldehyde is not well perceived by consumers.

### Use of the Invention

The present invention also relates to a novel use of at least one essential oil. Thereby, the above preferences apply. Thus, a preferred embodiment of the present invention relates to a novel use of eugenol, thymol or a mixture of eugenol and thymol. A particularly preferred embodiment of the present invention relates to a novel use of a powder that comprises a mixture of eugenol and thymol and that further comprises optionally at least one excipient.

The use of the present invention relates to the enhancement of the virucidal activity of benzoic acid flakes, preferably in feed. Thus, a preferred embodiment of the present invention relates to the use of the herein described powder for enhancing the virucidal activity of benzoic acid flakes, preferably in feed. In regard of African swine fever virus, the virucidal activity of benzoic acid or benzoic acid flakes is particularly enhanced.

Thus, a preferred embodiment of the present invention relates to the use of at least one essential oil for enhancing the virucidal activity of benzoic acid in feed, characterized in that said at least one essential oil enhances the capability of benzoic acid to inactivate African swine fever virus in pig feed. A particularly preferred embodiment of the present invention relates to the use of a mixture of eugenol and thymol for enhancing the virucidal activity of benzoic acid or benzoic acid flakes in feed, characterized in that said mixture enhances the capability of benzoic acid flakes to inactivate African swine fever virus in pig feed. An even more preferred embodiment of the present invention relates to the use of the herein described powder for enhancing the virucidal activity of benzoic acid (preferably benzoic acid flakes) in feed, characterized in that said mixture enhances the capability of benzoic acid (preferably benzoic acid flakes) to inactivate African swine fever virus in pig feed.

Thereby, the above cited preferences apply. Thus, the weight ratio between benzoic acid and eugenol is preferably at least 500:1, is more preferably at least 833:1 and is preferably at most 2500:1, whereas the weight ratio between benzoic acid and thymol is preferably at least 250:1, is more preferably at least 333:1 and is preferably at most 500:1. The same weight ratios apply if benzoic acid flakes are used.

The present invention further relates to use of benzoic acid and at least one essential oil, or preferably a composition or mixture comprising benzoic acid and at least one essential oil for at least partially inactivating African swine fever virus preferably in feed, more preferably in pig feed. The preferred benzoic acid, the preferred at least one essential oil and/or the preferred weight ratio between benzoic acid and at least one essential oil, as listed above in section “Use of the invention”, apply as well.

### Feed of the Invention

The feed of the invention may be any kind of feed. However, because pigs are preferred hosts of the African swine fever virus, the preferred feed of the invention is pig feed.

Benzoic acid as used in the context of the present invention does typically not fully destroy African swine fever virus. Whereas enhanced benzoic acid sufficiently inactivates African swine fever virus in pig feed, it is characteristic that harmless remains of the virus remain for a certain time in the pig feed after having applied the method of the invention. These harmless remains can be detected by PCR methods such as qPCR. Whereas harmless remains of inactivated African swine fever virus can be detected by PCR methods, no hemadsorption occurs in an hemadsorption assay in case of inactivated remains of African swine fever virus. Biological methods such as hemadsorption can be used to show that the remains of inactivated African swine fever virus are indeed harmless.

Therefore, once the method of the present invention has been applied, pig feed that comprises inactivated African swine virus, benzoic acid and at least one essential oil is obtained. If virucidal activity of benzoic acid or benzoic acid flakes is enhanced as herein described, pig feed that comprises inactivated African swine fever virus only may be obtained e. g. on day 9, day 6, day 3 and/or day 1 after the method of the present invention has been applied.

One embodiment of the present invention relates to pig feed comprising inactivated African swine virus, benzoic acid flakes and a mixture of essential oils, characterized in that said pig feed has been prepared less than 140 days ago, preferably less than 100 days ago, more preferably less than 50 days ago and most preferably less than 20 days ago. Such pig feed can be obtained even if it has been prepared in a country whose authorities have reported at least one outbreak of African swine fever within the last 12 months.

A preferred embodiment of the present invention relates to pig feed comprising inactivated African swine virus, benzoic acid flakes and at least one powder, wherein said powder comprises at least one essential oil and optionally at least one excipient, and wherein said at least one excipient is preferably 2-methoxyphenol, piperine and curcumin. In regard of the preferred essential oils, the preferred amounts of essential oils, and the preferred weight ratios of essential oils to benzoic acid, that herein disclosed preferences apply.

And also preferred embodiment of the present invention relates to pig feed comprising inactivated African swine virus, benzoic acid flakes and at least one powder, characterized in that said pig feed comprises:
0.25 to 0.5 weight-%, preferably 0.25 to 0.475 weight-%, more preferably 0.25 to 0.4 weight-% and most preferably of 0.25 to 0.39 weight-% benzoic acid flakes, based on the total weight of the pig feed, and
from 0.010 to 0.019 weight-% of a powder, based on the total weight of the feed, wherein said powder comprises eugenol and thymol and optionally further comprises at least one excipient as herein described.

Although not preferred, the pig feed could comprise further additives. However, the addition of formaldehyde, medium chain fatty acids, fumaric acid, propionic acid, 2-hydroxy-4-methylthio-butanoic acid and/or salts of 2-hydroxy-4-methylthio-butanoic acid (e.g. 2-hydroxy-4-(methylthio) butanoate calcium) to the pig feed of the invention is neither necessary nor preferred. It is preferred that the pig feed of the present invention is substantially free of formaldehyde, medium chain fatty acids, fumaric acid, propionic acid and/or salts of 2-hydroxy-4-methylthio-butanoic that has been added to the pig feed. Thereby, the expression “substantially free of” may refer to an amount of less than 0.2 weight-%, preferably less than 0.1 weight-%, even more preferably less than 0.01 weight-% and most preferably less than 0.001 weight-% of the respective compound, based on the total weight of the pig feed.

### Process of Preparing Feed of the Present Invention

The feed of the invention comprises inactivated African swine virus. Such feed can be prepared by inactivating African swine virus that is contained in contaminated feed ingredients. Feed ingredients as such may be contaminated or they may get contaminated in a feed mill during processing. Feed mills that are located in a country whose authorities have reported an outbreak of African swine fever are somewhat likely to be contaminated. Feed ingredients (such as corn, soya bean meal, barley and wheat bran) that are grown and/or purchased in such country are also somewhat likely to be contaminated. The risks of such potential contamination can be mitigated as herein described.

One embodiment of the present invention relates to a process of preparing pig feed in a country whose authorities have reported at least one outbreak of African swine fever within the last 12 months, characterized in that benzoic acid flakes and a powder are added to pig feed, wherein said powder comprises at least one essential oil, and comprises preferably a mixture of eugenol and thymol.

### EXAMPLES

### Example 1

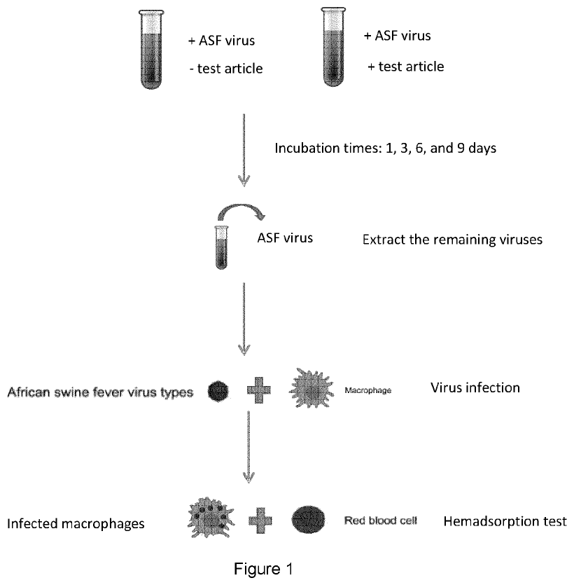

In example 1, an in vitro assay was done in phosphate-buffered saline (PBS) solution. An overview of this assay is depicted in FIG. 1.

The in vitro assay of example 1 was done as follows:
Step 1: dissolve test articles (VevoVitall® and VevoWin®, respectively) in PBS
Step 2: inoculate ASF virus [1 mL 10^{5.3} 50% hemadsorption doses (HAD₅₀)/ml] to 20 mL solutions and hold the contaminated solutions for 1, 3, 6 and 9 days.
Step 3: recover the live virus at the end of holding times and inoculate virus to porcine alveolar macrophages (PAM) cells for incubation
Step 4: add red blood cells (RBC) to infected PAM cells for hemadsorption test.

The result of the hemadsorption test is shown in below TABLE 1:

TABLE 1

PBS solution
Sampling time after virus inoculation, day

| Treatment | 1 | 3 | 6 | 9 |
|---|---|---|---|---|
| Positive | + + + + | + + + + | + + + + | + + + + |
| control | | | | |
| Negative | − − − − | − − − − | − − − − | − − − − |
| control | | | | |
| VevoVitall | + + − − | + − − − | + + − − | − − − − |
| VevoWin | + + + + | + + − − | + + − − | − − − − |

Four replicates were done for each test. *+* means hemadsorption, “−” means no hemadsorption. VevoVitall® is commercially available at DSM® Nutritional Products (Switzerland). It is a feed additive that consists essentially of benzoic acid (purity: approx. 99.9%). VevoVitall® are benzoic acid flakes. Such flakes can be manufactured at large volume and low cost. VevoWin® is a mixture of benzoic acid flakes and a powder that comprises a blend of essential oils. The powder's most prominent essential oils are thymol and eugenol.

Example 1 shows that if no additive (“test article”) is added, a holding time of 9 days is not sufficient to inactivate ASF virus (see positive control). Example 1 also shows that in PBS solution, the two tested articles (VevoVitall® and VevoWin®) performed similarly. In both cases, ASF virus was not fully inactivated before 9 days. Thus, in PBS solution, it seems challenging to enhance the virucidal activity of benzoic acid with essential oils.

### Example 2

In example 2, the assay of example 1 was repeated. This time, however, instead of PBS solution, a feed matrix was used.

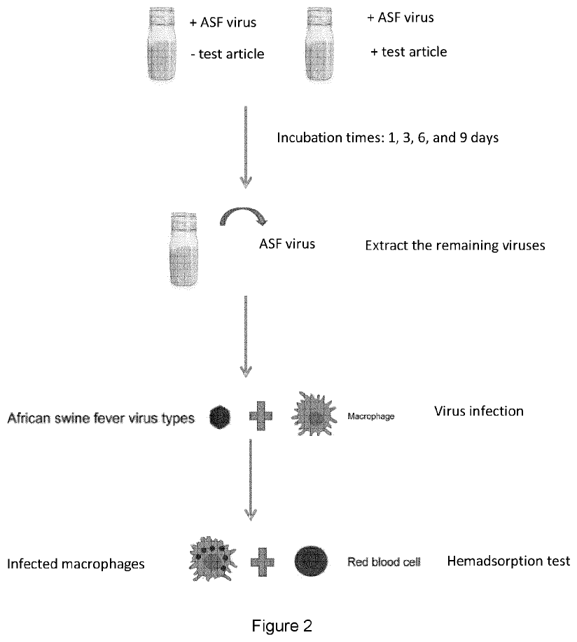

An overview of the assay of example 2 is depicted in FIG. 2.

In example 2, four diet samples from a pig diet were mixed individually in a miniature blade mixer either without addition of feed additives (“test article”) for negative control (NC) and positive control (PC) treatments or with 0.5 weight-% benzoic acid (Vevovitall®) treatment or with the combination of 0.5 weight-% benzoic acid and 0.02 weight-% essential oils (VevoWin®), based on the total weight of each feed sample. These treatment samples were gamma-irritated at 25 kGy before further operations in a BSL-3 laboratory. Four 10-gram sub-samples were weighed into centrifuge tubes. Each of the sample tubes of the PC, Vevovitall® and VevoWin® treatments was inoculated with 1 mL 10^{5.3} HAD₅₀/mL ASFV (ASFV/China/GZ201801). All the sample tubes were continuously rotated at 1,200 rpm/min to prevent clotting. For negative control (NC), no inoculation was done. On day 1, 3, 6 or 9 post inoculation (PI), each sample tube per treatment was taken for hemadsorption test. Ten mL PBS were added to each sample tube for collection of supernatant after centrifugation. The 100-fold diluted supernatant was used to infect porcine alveolar macrophages in plate wells for 2 h before the addition of RPMI 1640 medium. After 24-h incubation, red blood cells were added for hemadsorption test.

The result of the hemadsorption test of example 2 is shown in below TABLE 2:

TABLE 2

Feed matrix
Sampling time after virus inoculation, day

| Treatment | 1 | 3 | 6 | 9 |
|---|---|---|---|---|
| Positive | + + + + | + + + + | + + + + | + + + + |
| control | | | | |
| Negative | − − − − | − − − − | − − − − | − − − − |
| control | | | | |
| VevoVitall | + + + + | + + + − | − − − − | − − − − |
| VevoWin | − − − − | − − − − | − − − − | − − − − |

Again, four replicates were done for each test. *+* means hemadsorption, “−” means no hemadsorption. In example 2, the same products as in example 1 were tested (VevoVitall® and VevoWin®, respectively).

The negative control samples were tested negative for hemadsorption. The positive control of example 2 confirms that inoculation with ASF virus has been successful. The positive control also confirms that a holding time of nine days is not sufficient to inactivate ASF virus if no feed additive is added.

A comparison with example 1 shows that the effect of VevoVitall® is slightly better in feed than in PBS solution. Nevertheless, in feed, it still takes 6 days to fully inactivate the ASF virus.

Surprisingly, if a combination of benzoic acid and essential oils (i.e. VevoWin®) is added instead of benzoic acid alone (i.e. VevoVitall®), ASF virus is fully inactivated already at the end of day 1. Thus, in feed, essential oils enhance the virucidal activity of benzoic acid dramatically. As a result, holding time can be reduced.

### Example 3

In example 3, several batches pig feed are prepared in a country whose authorities have recently reported a severe outbreak of African swine fever. Batches 1 and 2 are prepared in a similar manner: benzoic acid flakes and powder comprising a mixture of essential oils are added to a pig diet. Whereas the components of the pig diet are the same in both batches, the respective pig diet originates from different regions: the pig diet of batch 1 is purchased in a far-away country that has been free of ASFV for a long time, whereas the pig diet of batch 2 has been grown locally. The result of example 3 is indicated below.

Batch 1 is produced on day 1. After 20 days, batch 1 does not contain living African swine virus and does also not contain any inactivated African swine virus. Thus, batch 1 is not contaminated and has never been contaminated with ASFV.

Batch 2 is produced on day 1. After 20 days, batch 2 does not contain living African swine virus. However, batch 2 contains inactivated African swine virus. Thus, the pig diet of batch 2 was contaminated. However, after a holding time of 20 days, batch 2 is no longer harmful; benzoic acid and the mixture of essential oils have successfully done their job.

Comparative batch 3 comprises pig diet only. The pig diet of comparative batch 3 has been grown locally. Neither benzoic acid nor any essential oil is added. After 20 days, comparative batch 3 contains living African swine virus. After 140 days, comparative batch 3 still contains living African swine virus. After a holding time of 500 days, comparative batch 3 is no longer harmful. Warehouse charges for those 500 days exceed 1,000 US$. In addition, a part of batch 3 is rotten and must be discharged.

1. Method of at least partially inactivating African swine fever virus in pig feed, characterized in that benzoic acid and at least one essential oil are added to pig feed.

2. Method according to claim 1, wherein no formaldehyde, no medium chain fatty acids, no fumaric acid, no propionic acid, no 2-hydroxy-4-methylthio-butanoic acid and/or no salt of 2-hydroxy-4-methylthio-butanoic acid is added to said feed.

3. Method according to claim 1, wherein benzoic acid flakes are added to said feed, wherein benzoic acid flakes are added preferably in an amount of 0.25 to 0.5 weight-%, more preferably in an amount of 0.25 to 0.475 weight-%, even more preferably in an amount of 0.25 to 0.4 weight-% and most preferably in an amount of 0.25 to 0.39 weight-%, based on the total weight of the pig feed.

4. Method according to claim 1, wherein said at least one essential oil is eugenol and/or thymol, and wherein a powder comprising a mixture of eugenol and thymol is preferably added to the pig feed.

5. Method according to claim 4, wherein the weight ratio between benzoic acid and eugenol is preferably at least 500:1, is more preferably at least 833:1 and is preferably at most 2500:1, and/or characterized in that the weight ratio between benzoic acid and thymol is preferably at least 250:1, is more preferably at least 333:1 and is preferably at most 500:1.

6. Use of benzoic acid and at least one essential oil for at least partially inactivating African swine fever virus in feed or use of at least one essential oil for enhancing the virucidal activity of benzoic acid in feed.

7. Use according to claim 6, wherein said at least one essential oil enhances the capability of benzoic acid to inactivate African swine fever virus in pig feed.

8. Use according to claim 6, wherein said at least one essential oil is eugenol and/or thymol, and wherein said at least one essential oil is preferably a powder that comprises a mixture of eugenol and thymol.

9. Pig feed comprising inactivated African swine fever virus, benzoic acid flakes and a powder, wherein said powder comprises at least one essential oil.

10. Pig feed according to claim 9, wherein said inactivated African swine virus can be detected by a PCR method, whereas no hemadsorption occurs in a hemadsorption assay.

11. Pig feed according to claim 9, wherein said pig feed has been prepared less than 140 days ago, preferably less than 100 days ago, more preferably less than 50 days ago and most preferably less than 20 days ago.

12. Pig feed according to claim 9, wherein said pig feed has been prepared in a country whose authorities have reported at least one outbreak of African swine fever within the last 12 months.

13. Pig feed according to claim 9, wherein said pig feed comprises less than 0.2 weight-%, preferably less than 0.1 weight-%, even more preferably less than 0.01 weight-% and most preferably less than 0.001 weight-% formaldehyde, fumaric acid, propionic acid, 2-hydroxy-4-methylthio-butanoic acid and/or salt of 2-hydroxy-4-methylthio-butanoic acid, based on the total weight of the pig feed.

14. Pig feed according to claim 9, wherein said pig feed comprises:
0.25 to 0.5 weight-%, preferably 0.25 to 0.475 weight-%, more preferably 0.25 to 0.4 weight-% and most preferably of 0.25 to 0.39 weight-% benzoic acid flakes, based on the total weight of the pig feed, and
from 0.010 to 0.019 weight-% of a powder, based on the total weight of the feed, wherein said powder comprises eugenol and thymol.

15. Process of preparing pig feed in a country whose authorities have reported at least one outbreak of African swine fever within the last 12 months, wherein benzoic acid flakes and a powder are added to pig feed, wherein said powder comprises at least one essential oil.
